(19) United States
(12) Patent Application Publication
(10) Pub. No.: US 2011/0258257 A1
(43) Pub. Date: Oct. 20, 2011

(54) PROXIMITY AGGREGATED NETWORK TOPOLOGY ALGORITHM (PANTA)

(75) Inventor: Stefano B. Previdi, Roma (IT)

(73) Assignee: Cisco Technology, Inc., San Jose, CA (US)

(21) Appl. No.: 12/763,266

(22) Filed: Apr. 20, 2010

(51) Int. Cl. G06F 15/16

(52) U.S. Cl. 709/205

(57) ABSTRACT

In one embodiment, each proximity server of a proximity network computes a distance from each particular location-community for which the proximity server is responsible to each location-community within the proximity network, wherein each distance is from a root location-community to a leaf location-community. The proximity servers may then share each computed distance with the other proximity servers within the proximity network, such that each proximity server in the proximity network maintains a distance between each location-community in the proximity network. Accordingly, a proximity server may then service proximity requests for content through performance of a lookup operation into the shared computed distances based on a root location-community being a location-community of an originator of the content requested within the proximity request and a leaf location-community being a location-community of a receiver of the content requested within the proximity request.

### TECHNICAL FIELD

The present disclosure relates generally to computer networks, and, more particularly, to proximity networks.

### BACKGROUND

Service Providers are currently implementing systems to deliver “proximity services” to application layer elements in order to improve any application selection scheme with certain topological hints. For instance, when a user client has to select among different peers or servers to receive content, it may be beneficial to determine which peer or server is closer, that is, within the proximity of the user client. The most common example of such a selection is related to peer-to-peer (P2P) networking, e.g., music, movies, photos, web content, etc. Other examples include such things as traditional content distribution/delivery networks (CDNs), where content is to be is delivered by the server closest to the user/requestor.

Current peer selections are performed in a sub-optimal fashion and often incur high resource usage in Service Provider infrastructure. Conversely, by “steering” or “influencing” peer selection through proximity services, Service Providers and P2P overlays may both improve performance/experience while more efficiently using infrastructure resources. Due to the number of peers and servers in a typical network, however, the scalability of proximity networks is limited to the ability of proximity servers to handle large numbers of proximity requests, and to simultaneously maintain an accurate view of the network topology to each and every peer and server in the network.

### BRIEF DESCRIPTION OF THE DRAWINGS

The embodiments herein may be better understood by referring to the following description in conjunction with the accompanying drawings in which like reference numerals indicate identically or functionally similar elements, of which:

s FIG. 1 illustrates an example computer network;

FIG. 2 illustrates an example network device/node;

FIG. 3 illustrates an example proximity network relationship;

FIG. 4 illustrates an example proximity aggregated network topology;

FIG. 5 illustrates an example data structure; and

FIG. 6 illustrates an example procedure for a proximity aggregated network topology algorithm.

### DESCRIPTION OF EXAMPLE EMBODIMENTS

### Overview

According to embodiments of the disclosure, each proximity server of a proximity is network computes a distance from each particular location-community for which the proximity server is responsible to each location-community within the proximity network, wherein each distance is from a root location-community to a leaf location-community. The proximity servers may then share each computed distance with the other proximity servers within the proximity network, such that each proximity server in the proximity network maintains a distance between each location-community in the proximity network. Accordingly, a proximity server may then service proximity requests for content through performance of a lookup operation into the shared computed distances based on a root location-community being a location-community of an originator of the content requested within the proximity request and a leaf location-community being a location-community of a receiver of the content requested within the proximity request.

### DESCRIPTION

A computer network is a geographically distributed collection of nodes interconnected by communication links and segments for transporting data between end nodes, such as personal computers and workstations. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet is Protocol (TCP/IP). In this context, a protocol consists of a set of rules defining how the nodes interact with each other. Computer networks may be further interconnected by an intermediate network node, such as a router, to extend the effective “size” of each network.

Since management of interconnected computer networks can prove burdensome, smaller groups of computer networks may be maintained as routing domains or autonomous systems. The networks within an autonomous system (AS) are typically coupled together by conventional “intradomain” routers configured to execute intradomain routing protocols, and are generally subject to a common authority. To improve routing scalability, a service provider (e.g., an ISP) may divide an AS into multiple “areas” or “levels.” It may be desirable, however, to increase the number of nodes capable of exchanging data; in this case, interdomain routers executing interdomain routing protocols are used to interconnect nodes of the various ASes. Moreover, it may be desirable to interconnect various ASes that operate under different administrative domains. As used herein, an AS, area, or level may generally be referred to as a “domain.”

FIG. 1 is a schematic block diagram of an example computer network 100 illustratively comprising nodes/devices, such as one or more routers 110, interconnected by links as shown. Illustratively, the routers 110 may interconnect user client devices 310 to each other, as well as to one or more proximity servers 320 (which may be co-located within a router 110), in accordance with one or more embodiments described herein. Those skilled in the art will understand that any number of nodes, devices, links, etc. may be used in the computer network, and that the view shown herein is for simplicity. Data packets 140 (e.g., traffic/messages) may be exchanged among the nodes/devices of the computer network 100 using predefined network communication protocols such as TCP/IP, User Datagram Protocol (UDP), Asynchronous Transfer Mode (ATM) protocol, Frame Relay protocol, Internet Packet Exchange (IPX) protocol, etc.

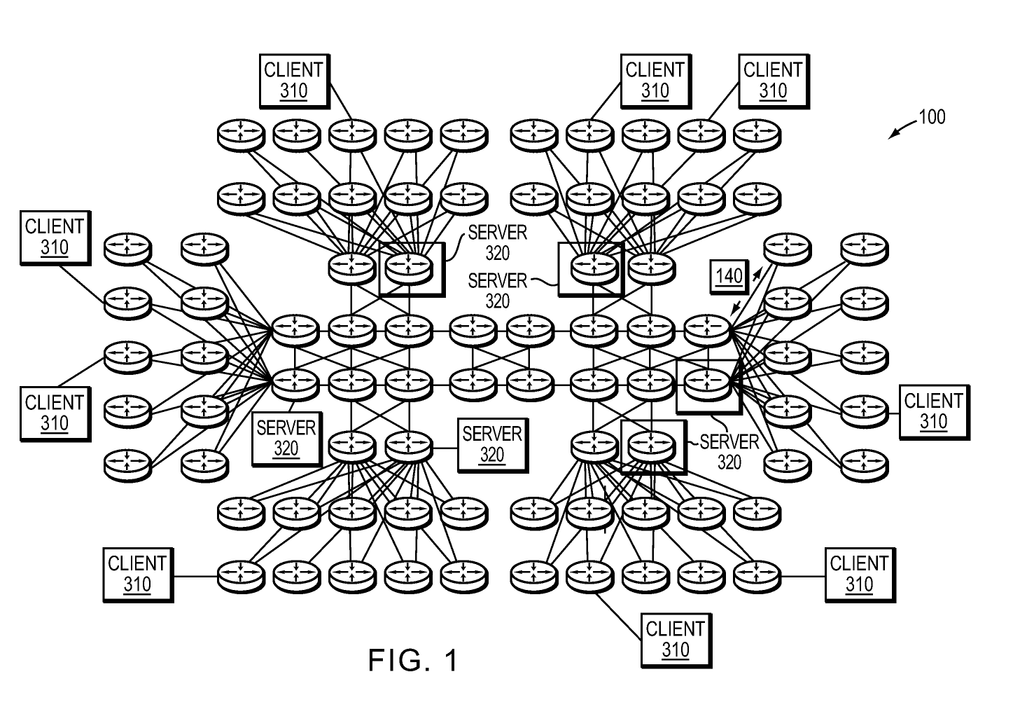

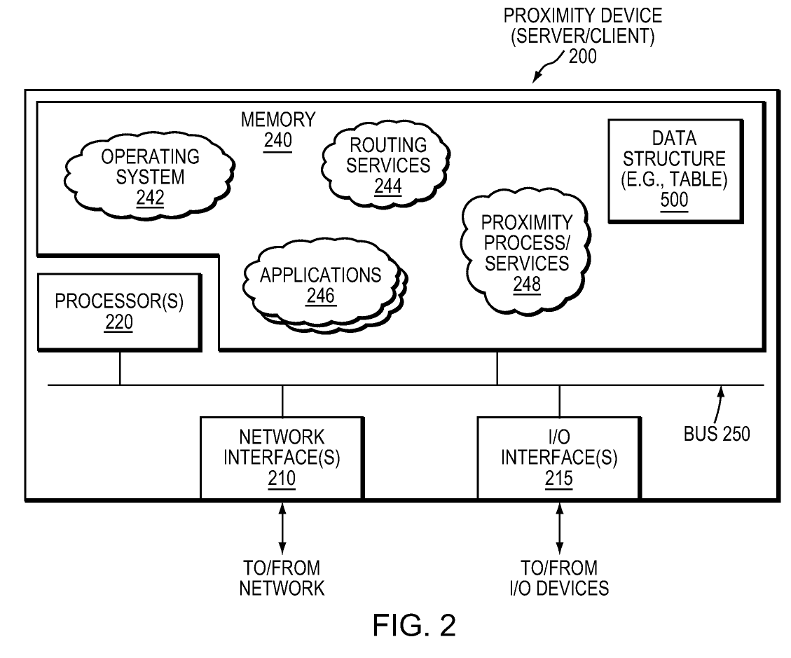

FIG. 2 is a schematic block diagram of an example node/device 200 that may be used with one or more embodiments described herein, e.g., as a proximity device (client 310 or server 320) or router. The device comprises one or more network interfaces 210, is one or more input/output (I/O) interfaces 215 (for I/O devices), one or more processors 220, and a memory 240 interconnected by a system bus 250. The network interfaces 210 contain the mechanical, electrical, and signaling circuitry for communicating data over physical links coupled to the network 100. The network interfaces may be configured to transmit and/or receive data using a variety of different communication protocols, including, inter alia, TCP/IP, UDP, ATM, synchronous optical networks (SONET), wireless protocols, Frame Relay, Ethernet, Fiber Distributed Data Interface (FDDI), etc. Notably, a physical network interface 210 may also be used to implement one or more virtual network interfaces, such as for Virtual Private Network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 500, such as a shared distances database/table 500. An operating system 242, portions of which are typically resident in memory 240 and executed by the processor(s), functionally organizes the node by, inter alia, invoking operations in support of software processes and/or services executing on the device. These software processes and/or services may comprise routing services 244 (e.g., for routers 110 and servers 320), one or more applications 246 (e.g., for clients 310), and proximity services 248 (e.g., for both servers and clients), as described in more detail herein. It will be apparent to those skilled in the art that other types of processors and memory, including various computer-readable media, may be used to store and execute program instructions pertaining to the techniques described herein. Illustratively, the processes/services may alternatively be embodied as modules within the device 200.

Routing services 244 contain computer executable instructions executed by the processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. These functions may be is configured to manage a forwarding information database containing, e.g., data used to make forwarding decisions. In particular, changes in the network topology may be communicated among devices 200 (e.g., routers 110 and servers 320) using routing protocols, such as the conventional OSPF and IS-IS link-state protocols or BGP (e.g., to “converge” to an identical view of the network topology). Notably, routing services 244 may also perform functions related to virtual routing protocols, such as maintaining VRF instances, or tunneling protocols, such as for Multi-Protocol Label Switching, etc., each as will be understood by those skilled in the art.

As noted above, “proximity services” may be offered by Service Providers to improve an application selection scheme by using actual topology, such as by determining which peer or server is closer when a user client needs to select among different peers or servers to receive content. For example, proximity services may be used with many current application networking architectures, such as content distribution/delivery networks (CDNs) or content distribution services/systems (CDS s), peer-to-peer (P2P) networking, social networking, streaming data, voice over IP (VoIP), IP television (IPTV), gaming, music, movies, photos, web content, etc. Commonly, these architectures are bandwidth-intensive and time-sensitive, and require location-independent and mobility-capable solutions. Approaches in the past have included such thing as load balancing/sharing, replication/pre-positioning, caching, etc. Proximity services, on the other hand, provides the ability to locate content and users (e.g., mobile users), and to re-direct users to a closest instance of a content/service, such as by selecting caches/servers based on the distance to the client, or selecting conference bridges close to the user client's location, etc. One example architecture for proximity networks is described in commonly owned, copending U.S. patent application Ser. No. 12/368,436, entitled “Routing-Based Proximity For Overlay Networks,” filed on Feb. 10, 2009 by Stefano B. Previdi et al.

Generally speaking, “proximity services” is a set of functions that are designed to answer queries of the form: “which of several candidate nodes are closest to some point of interest?” For example, a client may want to locate a nearest copy of content, such as a closest set of peers in a P2P network or a closest CDN cache for given content. Alternatively, a client may want to locate a closest instance of a service among several available resources, such as a closest VoIP bridge/server or a shared voice conferencing bridge for users grouped by location. Proximity may thus be used to optimize selection mechanisms/algorithms at the application layer, where a proximity client sends a request with a list of possible routing IDs from which to chose (e.g., addresses, prefixes, AS numbers, etc.), and a proximity server returns topology information by delivering a location-based ranking of those routing IDs, e.g., using routing algorithms adapted for proximity purposes and tailored by any application-specific requirements. Notably, proximity servers do not typically enforce client selection. Note further that as used herein, “proximity” may generally refer to proximity networks, CDNs, and CDS s interchangeably.)

Network-based proximity services provide the benefit of drawing on access to network topology, policy information, and resource information, as opposed to typical proximity overlay systems. For instance, network-based proximity servers may build trees according to network topology, and avoid a “zig-zag” problem associated with non-network-based proximity techniques, as may be understood by those skilled in the art. Accordingly, by using same topology information as used for routing (e.g., not derived from third parties), there is a consistency between routing/forwarding decisions and proximity decisions. Further, information is kept up to date by the routing layer, adapting to network events, and may leverage existing (and future) routing protocol enhancements. Notably, proximity is generally an application agnostic service, where the application is transparent to the proximity servers. As such, there remains confidentiality between the routing layer and application layer, that is, routing information is not leaked and application information (e.g., client-ID, content-ID, etc.) is not disclosed.

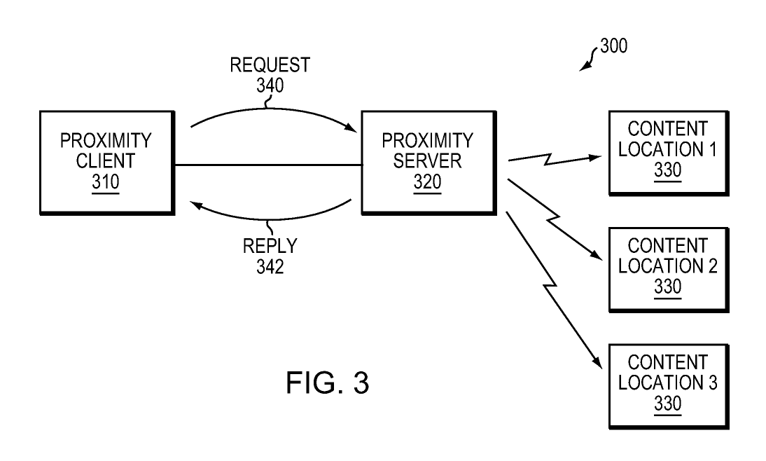

FIG. 3 illustrates a simplified example proximity arrangement 300, where a proximity server 320 is configured to deliver proximity services to one or more clients 310. A proximity client 310 may be a process or module, e.g., embedded into an application client (e.g., proximity application 248 on a client device) or embedded within an application server/portal, that is interested in improving its selection process through ranked lists delivered by the proximity server 320. Illustratively, the application client (e.g., a consumer device) may learn of the proximity server's address through various means, such as a domain name server (DNS), Anycast services, dynamic host configuration protocol (DHCP), etc., and implements a proximity API (application programming interface) according to one or more proximity protocols. Through the execution of one or more applications (246/248), the user client 310 may perform a content search, such as searching a particular movie title. In doing so, it may learn a plurality of locations 330 (e.g., 1, 2, 3) from which to download the selected content/service, and then sends a request 340 to the proximity server 320 to determine the closest/best location.

The proximity server 320 (e.g., a provider device) services the requests to returns responses 342 with ranked lists of content/service locations. A proximity server 320 may be a standalone network device, or may be a portion (e.g., module) of a more general purpose device, such as a router or “service router” (SR). The server 320 interfaces with the network/routing layer, such as peering with various routing protocols (BGP, ISIS, OSPF, etc.) and integrates policies and state information (e.g. link utilization, server load, etc.) to make the appropriate “closeness” ranking. Note that “closeness” may imply different meanings in different contexts, such as routing cost, state information (e.g., round trip time or “RTT”), policies/preferences (e.g., based on time of day), etc. Generally, however, closeness is based on the direction of the content flow, i.e., from the source of the content to the receiver of the content.

The requests 340 and replies 342 generally include a Proximity Source Address (PSA) and a Proximity Target List (PTL). The PSA contains the address (e.g., IP address, prefix, etc.) of an endpoint for which ranking services are requested (e.g., the address to which content is to be delivered), while the PTL contains a list of endpoint addresses that needs to be ranked according to their distance from/to the PSA. For example, in FIG. 3, the request 340 may signify that the client 310 has an address of “IP4,” and wants to know who among “IP1,” “IP2,” and “IP3” is closest (e.g., corresponding to content locations 1, 2, and 3). An example reply 342 may include a ranked list of “IP3, IP1, IP2,” in increasing order of distance to IP4. From this, the client 310 may select a content location (e.g., IP3) from which to receive the content/services.

As noted above, due to the number of peers and servers in a typical network, the scalability of proximity networks is limited to the ability of proximity servers to handle large numbers of proximity requests, and to simultaneously maintain an accurate view of the network topology to each and every peer and server in the network. According to embodiments of the disclosure, therefore, the proximity servers 320 may be configured to pre-compute an aggregated (e.g., summarized) network topology, such that the topology is based on “location-communities.” For instance, an aggregated topology reflects groups of users sharing a common location characteristic/ID, such as, in one or more embodiments, a same BGP community attribute. In this manner, each proximity server in the network may pre-compute an inter-group or inter-community cost/distance based on its network visibility, rather than having to compute and store costs/distances between each and every content/service source and receiver in the proximity network. The proximity requests may then be efficiently serviced based on this aggregated topology information, based on inter-community costs rather than a distance (e.g., pure hop counts) between endpoints.

Illustratively, then, one or more embodiments of the disclosure leverage the routing layer and provide an innovative scheme/algorithm in order to aggregate network topology for making it more usable by the application layer. Through extended proximity algorithms and protocols herein, a network-based proximity implementation may (pre-)compute accurate aggregated network topology information in order to scale the ability of a proximity server to handle requests (e.g., in terms of number of requests per second). Further, as described herein, proximity servers may be interconnected (e.g., through Distributed Hash Tables or “DHT”) in order to share the different pre-computed aggregated topologies so that, once pre-computation has been performed, the proximity service may be delivered through lookup operations into a stored table, rather than triggering subsequent computations. Moreover, the pre-computed aggregated topology may be shared with the application layer without affecting confidentiality or security.

The techniques described herein may be performed by hardware, software, and/or firmware, such as in accordance with a proximity process 248, which may contain is computer executable instructions executed by the processor 220 to perform functions relating to the novel techniques described herein. In particular, proximity servers 320 may use proximity process 248 to pre-compute an aggregated network topology using algorithms as described herein, and may communicate with other servers to correlate/combine the different proximity servers' computations, such as through a service routing layer (e.g., DHT based). The processes and algorithms described here below extend and improve upon basic proximity algorithms provide a scalable, more accurate proximity service that is capable of being deployed in many different scenarios.

Operationally, it is assumed that a proximity server resides at each location in the network where proximity services are to be delivered. In general this implies a proximity server in each POP (point of presence) as peer-to-peer overlays are present nearly everywhere in today's network topology. The proximity servers (320) interface with the routing layer and dynamically collect a routing database, such as through routing services 244. In addition, the proximity aggregated network topology algorithm is based on aggregated “location-communities” represents a location where a route has been originated that is made up of one or more nodes (e.g., content/services sources and receivers) sharing a same group identifier (ID). For instance, all addresses or address prefixes belonging to the same group ID may be computed as if they were attached to the network via the same node, e.g., are part of a same generally geographical group.

According to one or more illustrative embodiments, the group IDs may be derived from routing topology information, such that the proximity algorithm may leverage the location-communities to create the aggregated topology based on actual, and accurate, topological knowledge. For example, many (e.g., most) service providers currently use BGP communities (community attributes) in order to (among other things) identify a location or “site of origin” of customer routes according to their own numbering scheme, such as to distinguish POPs or cities and/or regions. Other or additional grouping schemes may also be deployed, such as autonomous system (AS) numbers, also derived routing information, as well as configuring particular sets of selected prefixes (e.g., per location-community). Further, other techniques may be used to distinguish routes based on geographic location (e.g., other identifiers that may be manually configured or carried is within routing protocols). The aggregating algorithm described herein may thus leverage such location-community distinguishing schemes in order to aggregate network topology for the use of application proximity services.

Notably, there are cases (e.g., P2P networking) where the granularity of the location is no longer the POP but rather the region or the AS. Selecting a particular type of group ID will allow the service provider to assign to its customer base a given group ID in order to represents the AS and location of the customer prefix. Therefore, the group ID can be used to modify the aggregation level derived from routing information (e.g., BGP communities) by either increasing the aggregation by grouping multiple communities into a single group ID or decreasing the aggregation by splitting a given BGP community into multiple groups. For instance, as mentioned above, particular sets of selected prefixes may be used distinguish nodes having a same BGP community attribute. That is, a location-community may consist of a subset of one or more nodes in the proximity network sharing a group ID. For example, the subset may be identified based on a secondary identification, such as, e.g., customer types, customer profiles, content serviced, bandwidth configuration, etc.

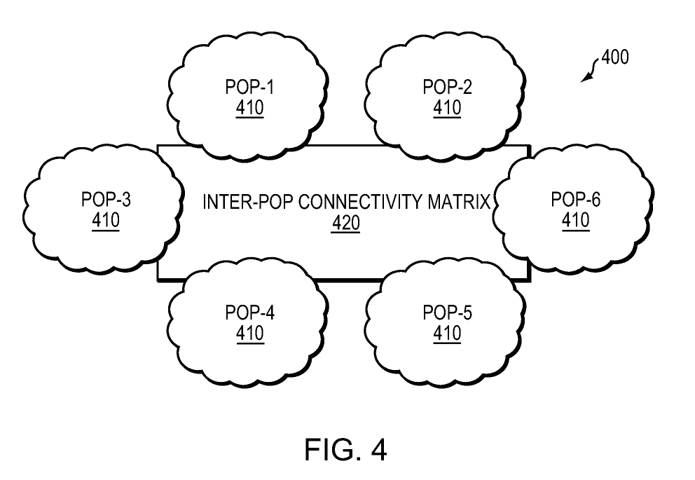

FIG. 4 illustrates an example aggregated network topology 400 in accordance with one or more embodiments herein. For instance, assuming the routing topology shown in FIG. 1, one illustrative embodiment may have resulted in each “cluster” of devices sharing a routing identification value, such as a BGP community attribute. For ease of discussion, assume that the BGP community attributes are “1” through “6”, representing POPs 1-6 as shown. Accordingly, the grouped location-communities 410 may correspond to the POPs 1-6 based on the shared BGP community attributes of the devices within the “clusters.” The location-communities 410 may then be interconnected by a connectivity matrix 420, such as a service provider's core network.

According to one or more embodiments herein, each proximity server 320 pre-computes an aggregate topology based on the location-communities. An illustrative purpose of the aggregated topology computation is to determine a distance between communities of devices/prefixes, and not the specific distance between each and every device/prefixes. To begin the computation, the server 320 may locate (e.g., within a link is state database or “LSDB”) all nodes originating routes (content) within a location-community for which the proximity server is responsible (or, alternatively, can see). Originators, generally, may consist of BGP routers whose address (/32 prefix or system ID) is used as a next-hop for client devices 310, and that are available in the LSDB (ISIS, OSPF, etc.). Note that the proximity server is generally only interested in location-community originators located inside the link-state area. Once located, these originators may be sorted by location-community, where each group of originators represents the location-community for the purpose of the computation.

Subsequently, for each location-community (e.g., originated within the area for which the server is responsible), the proximity server performs a shortest path first (SPF) computation based on the underlying routing topology to compute a Forward shortest path tree (SPT). The SPF is used pre-compute a distance from each particular location-community for which the proximity server is responsible to each location-community within the proximity network. Specifically, the distances are computed from “root” location-communities to “leaf” location-communities. Note that within each POP (e.g., in each location-community), the distance from an edge device (where customer routes are originated) to the distribution/core routers may be kept constant (i.e., no substantial differences). In other words, within a POP, all edge routers generally have similar distances to the core network 420.

Illustratively, for a given location-community, all originators may be used as a root for the tree computation, such that the SPT starts with insertion into a tentative or “TENT” list (with root-distance set to 0 for each) of all nodes originating routes within the root location-community for which the tree computation is being performed. The computation may proceed according to an SPF algorithm, computing a distance from the (e.g., multiple) root nodes to any other node advertising location-community, that is, terminating at one or more leaf nodes in other leaf location-communities of the proximity network.

The SPF computation is generally based on a conventional SPF, however certain modifications may be made to accommodate one or more embodiments herein. For instance, the roots of a computation are originators having a shared location-community, is while a valid leaf node of interest is an originator of any other location-community. Generally, there is no interest in core/backbone routers (as they are not originators), and an actual tree need not be maintained. That is, since the computation is interested in leaf nodes, it does not need to keep any state for intermediate nodes.

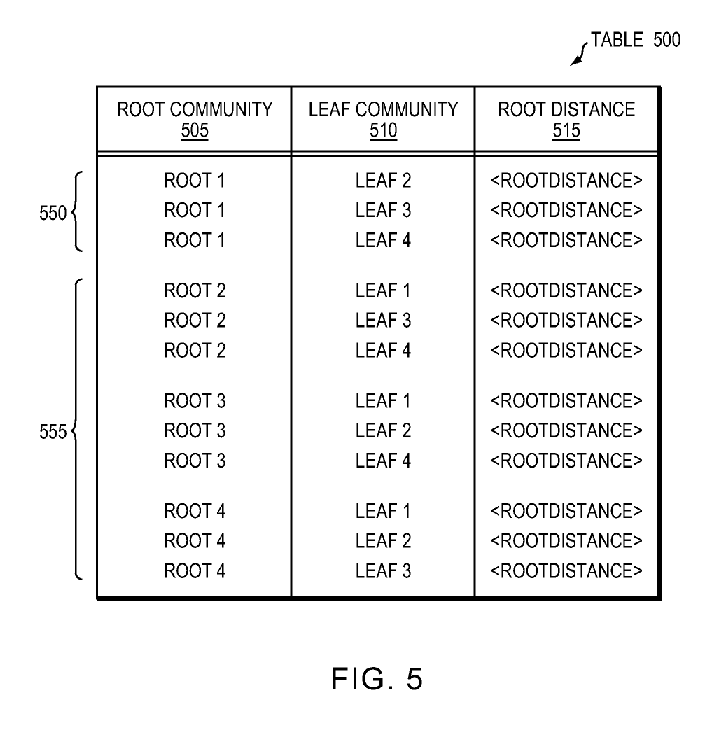

Each SPF computation results in a “root distance” (e.g., cost, hop count, etc.) from each particular root location-community (the root nodes) to each other location-community in the proximity network as a leaf location-communities (the leaf nodes). FIG. 5 illustrates an example table 500 that may be used to store the results of the computed SPFs. In particular, the computer SPFs may be used to derive the table that represents the distance from/to each set of location-communities, thus resulting in an aggregation of the actual network topology. Table 500 may comprise a plurality of entries 550 comprised of fields containing a root community identification 505, a leaf community identification 510, and a root distance (or cost) 515. Note that while a table is shown, other formats may be used as a storage data structure, such as lists, databases, etc., and the use of a table is merely an example.

The root community 505 of an entry 550 represents the location-community used as root of the computation, while the leaf community 510 of that entry represents a location-community (e.g., having at least one known destination) from within the proximity network other than the root. The root distance value 515 is the pre-computed distance from the root location-community to the leaf location-community of that particular entry. In the event a plurality of distances are pre-computed from a particular root location-community to a particular leaf location-community, then the root distance for that particular pair may be set to one of a plurality of configurable selections. For instance, the root distance may be set to the smallest distance encountered during SPF computation, the largest distance, or a computed average distance from the plurality of distances.

Once a proximity server pre-computes its distances from root communities for which it is responsible (or, alternatively, for which it has visibility), the server may share these distances with one or more other proximity servers within the proximity network, is such that each proximity server in the proximity network maintains a distance between each location-community in the proximity network. For instance, each proximity server in the network computes an SPT per location-community, and shares (or publishes) its set to the collection of proximity servers in the network. Each other proximity server will do the same, and the table 500 grows to contain all values from SPTs rooted at each location-community. In this manner, each proximity server can access any tree from any location-community source (root community) to any location-community destination (leaf community). Entries 555 in the table 500 illustrate a completed table for a network having the four location-communities, and the table (global file) represents the connectivity matrix between location-communities (i.e., the distance between the location-community used as root of the SPF and any other location-community in the network). In one or more embodiments, a distributed hash table (DHT) protocol may be utilized to distribute the shared tables, i.e., the distance between each location-community in the proximity network. (As shown, table 500 is abbreviated for simplicity to illustrate a proximity network containing four location-communities, and not the six location-communities shown in FIG. 4.)

Notably, according to one or more embodiments herein, it may be possible to have overlapping visibility/responsibility between proximity servers. As such, it may be correspondingly possible to have each proximity server compute distances from root location-communities for which is it responsible (that are visible) that have not already been computed and distributed into the global table 500. For instance, assume that a first server can see root location-community 2, while a second server can also see root location-community 2. If the table 500 has already been populated for root location-community 2 to each other leaf location-community by the first server, then the second server need not re-compute the distances. Alternatively, the second server may re-compute the distances, and in the event of any discrepancies, either re-distribute the new distance values, or maintain preference of its locally computed values (e.g., where possibly different computations were used).

From the user client perspective, the client 310 may connect to the proximity server (e.g., identify/login), such as when registering for a proximity service through the hypertext transport protocol (http) or any other suitable transport protocol. Subsequently, the client may request and receive the client's group ID value (i.e., its location-community). Note that the client may cache this ID and/or may request this value for each login in order to account for mobility of the client device, or for changes in the grouping scheme.

Based on one or more applications 246, the clients 310 may generate a proximity request 340 for their corresponding server to determine which content/service nodes are closer in proximity from a list of suitable options, as described above. In one or more embodiments herein, clients who know the location-communities of their peers (e.g., via a P2P overlay or otherwise) may send proximity requests to their appropriate servers based on the location-community values only. For instance, the requests 340 may simply contain a PSA and PTL having location-community values (group IDs). Alternatively, clients not knowing location-communities may send IP-based proximity requests (PSA/PTL as IP addresses), and the proximity servers may then determine the corresponding location-community (group ID) for each PSA/PTL address (e.g., through a lookup operation).

The receiving proximity server 320 may then service the proximity request by performing a lookup operation into the shared pre-computed distances (e.g., table 500) based on the PSA and PTL location-communities (e.g., group IDs). In other words, the lookup may be performed based on a root location-community being a location-community of an originator of the content requested within the proximity request and a leaf location-community being a location-community of a receiver of the content requested within the proximity request. Based on the closeness of the location-communities, the server may then return a ranked list in a response 342 accordingly. Illustratively, the ranked list may represent location-community ranks or IP ranks, according to the values received in the request as mentioned above.

Notably, the proximity replies may be stored/cached in the user clients (e.g., memory 240), reducing the number of requests sent to the servers. Also, due to the aggregated information contained in the replies, there are fewer entries that the client would have to store/cache as compared to individual prefixes. That is, by maintaining is information about distance/ranks between location-communities rather than prefixes, there is less information to maintain, and the information based on the aggregated topology may remain more stable having the ability to “hide” small changes in the underlying routing topology.

In addition, in the event that any network event is detected by a proximity server, such as through routing protocols, each detecting server may then re-compute its routing databases (e.g., IGP/BGP) and trees accordingly. The aggregation process may then also be re-executed in the affected proximity server(s) and, if needed, the global matrix file may be updated by distributing the newly pre-computed information. In this manner, the aggregated proximity is maintained accurate in relation to changes in the underlying routing topology.

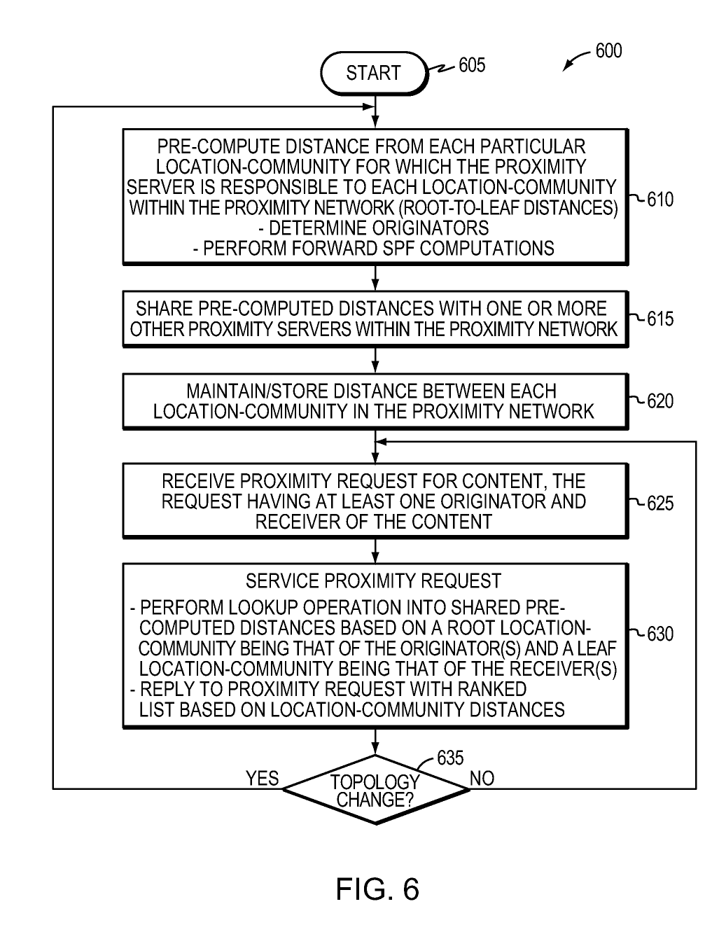

FIG. 6 illustrates an example simplified procedure for a proximity aggregated network topology algorithm in accordance with one or more embodiments described herein. The procedure 600 starts at step 605, and continues to step 610, where each proximity server 320 pre-computes the distance from each particular location-community 410 for which that proximity server is responsible (e.g., can “see”) to each location-community 410 within the proximity network (root-to-leaf distances) 400. For instance, as described above, each proximity server may determine originators within its visible location-communities, and may then perform forward SPF computations for each location-community rooted at the one or more originators within those location-communities. Once pre-computed, the proximity servers may share the distances with one or more other proximity servers within the proximity network in step 615, such that each proximity server may maintain/store a distance between each location-community in the proximity network in step 620 (e.g., within table 500).

Upon receiving a proximity request 340 for content in step 625, where the request has at least one originator and receiver of the content, a proximity server may service the request in step 630 accordingly. In particular, the server may perform a lookup operation into the shared pre-computed distances (e.g., table 500) based on a root location-community being that of the originator(s) and a leaf location-community being that of the receiver(s), as described in more detail above. Also, through servicing the request, the proximity server may reply with a ranked list based on the pre-computed location-community distances, e.g., within a reply 342.

The procedure 600 may continue to receive proximity requests in step 625 and service them in step 630. Also, if in step 635 a topology change occurs (e.g., is detected), then a proximity server may return to step 610 to pre-compute the distances based on the changed topology. Notably, other stimuli may trigger a new computation in step 610, such as periodic timers, specific (e.g., manual) requests, etc.

The novel techniques described herein provide a proximity aggregated network topology algorithm for use in proximity computer networks. By pre-computing an aggregated network topology leveraging routing layer protocols (such as IGP/BGP), the novel techniques allow a proximity server to efficiently respond to requests of address/location rankings through a lookup operation for the optimization of application selection processes, e.g., for service routing (SR) and CDS architectures. In particular, the techniques described above increase scalability in terms of the number of requests per second the proximity server is capable to sustain, and improve the caching ability in proximity clients in order to reduce the number of requests in the first place. Further, by sharing the aggregated topologies (e.g., distances) among proximity servers (e.g., through DHT), the servers are able to maintain an accurate view of the current topology, even beyond their typical visibility. Moreover, the techniques reduce the impact of peer to peer applications in the network, while ensuring security and confidentiality of layer-specific information (e.g., specific routing topology).

While there have been shown and described illustrative embodiments that provide a proximity aggregated network topology algorithm for use in proximity computer networks, it is to be understood that various other adaptations and modifications may be made within the spirit and scope of the disclosure. For example, the embodiments have been shown and described herein directed to “proximity” servers, networks, and requests. However, the embodiments of the disclosure in their broader sense are not so limited, and may, in fact, be used with other locality-based and distance-based network overlays is (localization techniques) that perhaps utilize different protocols than what may be considered a typical “proximity overlay.” Also, while certain computations and metrics (distances) are shown for pre-computing the shared aggregated location-community lookup list, such as SPF and costs, other computations and metrics may be used as desired to determine a ranking of available originators and/or receivers, e.g., their proximity.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible computer-readable medium (e.g., disks/CDs/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
computing, at a proximity server of a proximity network, a distance from each particular location-community for which the proximity server is responsible to each location-community within the proximity network, each distance computed from a root location-community to a leaf location-community;
sharing each computed distance with one or more other proximity servers within the proximity network, such that each proximity server in the proximity network maintains a distance between each location-community in the proximity network; and
servicing a proximity request for content at the proximity server through performance of a lookup operation into the shared computed distances based on a root location-community of an originator of the content and a leaf location-community of a receiver of the content .

2. The method as in claim 1, wherein computing comprises:
determining, at the proximity server, one or more originators originating content from within the particular location-communities for which the proximity server is responsible; and
performing a forward shortest path first (SPF) computation for each of the particular location-communities, the SPF computation for each particular location-community using at least one of the one or more originators from within that particular location-community as a root node of the computation for the corresponding root location-community and terminating at one or more leaf nodes in other leaf location-communities of the proximity network, each SPF computation resulting in the distance from each particular location-community as a root location-community to each other location-community in the proximity network as a leaf location-community.

3. The method as in claim 2, wherein a plurality of distances are computed from a particular root location-community to a particular leaf location-community, the method further comprising:
selecting a smallest distance from the plurality of distances as the computed distance from the particular root location-community to the particular leaf location-community.

4. The method as in claim 2, wherein a plurality of distances are computed from a particular root location-community to a particular leaf location-community, the method further comprising:
selecting a largest distance from the plurality of distances as the computed distance from the particular root location-community to the particular leaf location-community.

5. The method as in claim 2, wherein a plurality of distances are computed from a particular root location-community to a particular leaf location-community, the method further comprising:
computing an average distance from the plurality of distances; and
selecting the average distance as the computed distance from the particular root location-community to the particular leaf location-community.

6. The method as in claim 1, further comprising:
identifying each location-community based on a set of one or more nodes in the proximity network sharing a group identifier (ID).

7. The method as in claim 1, further comprising:
identifying each location-community based on a set of one or more nodes in the proximity network sharing a border gateway protocol (BGP) community attribute.

8. The method as in claim 1, further comprising:
identifying each location-community based on a set of one or more nodes in the proximity network sharing an autonomous system (AS) number.

9. The method as in claim 1, further comprising:
identifying each location-community based on a set of one or more nodes in the proximity network sharing a geographic location.

10. The method as in claim 1, further comprising:
identifying each location-community based on a set of one or more nodes in the proximity network belonging within a particular set of selected prefixes per location-community.

11. The method as in claim 1, further comprising:
identifying each location-community based on a subset of one or more nodes in the proximity network sharing a group identifier (ID), wherein the subset is identified based on a secondary identification.

12. The method as in claim 11, wherein the secondary identification is selected from a group consisting of: customer type, customer profile, content serviced, and bandwidth configuration.

13. The method as in claim 1, wherein sharing comprises:
utilizing a distributed hash table (DHT) protocol to distribute the distance between each location-community in the proximity network.

14. An apparatus, comprising:
one or more network interfaces adapted to communicate in a proximity network having a plurality of location-communities;
a processor coupled to the network interfaces and adapted to execute one or more processes; and
a memory adapted to store a process executable by the processor, the process when executed operable to:
compute and store a distance from each particular location-community for which the apparatus is responsible to each location-community within the proximity network, each distance computed from a root location-community to a leaf location-community;
receive and store computed distances from other apparatuses within the proximity network; and
service a proximity request for content through performance of a lookup is operation into the stored computed distances based on a root location-community of an originator of the content and a leaf location-community of a receiver of the content.

15. The apparatus as in claim 14, wherein the process when executed is operable to compute distances through:
a determination of one or more originators originating content from within the particular location-communities for which the apparatus is responsible; and
performance of a forward shortest path first (SPF) computation for each of the particular location-communities, the SPF computation for each particular location-community using at least one of the one or more originators from within that particular location-community as a root node of the computation for the corresponding root location-community and terminating at one or more leaf nodes in other leaf location-communities of the proximity network, each SPF computation resulting in the distance from each particular location-community as a root location-community to each other location-community in the proximity network as a leaf location-community.

16. The apparatus method as in claim 15, wherein a plurality of distances are computed from a particular root location-community to a particular leaf location-community, and the computed distance from the particular root location-community to the particular leaf location-community is selected from a group consisting of: a smallest distance from the plurality of distances; a largest distance from the plurality of distances; and a computed average distance from the plurality of distances.

17. The apparatus as in claim 14, wherein each location-community is identified based on a set of one or more nodes in the proximity network sharing a group identifier (ID).

18. The apparatus as in claim 17, wherein the group ID is selected from a group consisting of: a border gateway protocol (BGP) community attribute; an autonomous system (AS) number; a geographic location indicator; and any prefix that belongs within a particular set of selected prefixes per location-community.

19. A tangible computer-readable media having software encoded thereon, the software when executed on a proximity server of a proximity network operable to:
compute a distance from each particular location-community for which the proximity server is responsible to each location-community within the proximity network, each distance computed from a root location-community to a leaf location-community;
share each computed distance with one or more other proximity servers within the proximity network, such that each proximity server in the proximity network maintains a distance between each location-community in the proximity network; and
service a proximity request for content through performance of a lookup operation into the shared computed distances based on a root location-community of an originator of the content and a leaf location-community of a receiver of the content.

20. The tangible computer-readable media as in claim 19, wherein the software when executed is operable to compute by:
determination of one or more originators originating content from within the particular location-communities for which the proximity server is responsible; and
performance of a forward shortest path first (SPF) computation for each of the particular location-communities, the SPF computation for each particular location-community using at least one of the one or more originators from within that particular location-community as a root node of the computation for the corresponding root location-community and terminating at one or more leaf nodes in other leaf location-communities of the proximity network, each SPF computation resulting in the distance from each particular location-community as a root location-community to each other location-community in the proximity network as a leaf location-community.
